(19) United States
(12) Patent Application Publication
(10) Pub. No.: US 2025/0229842 A1
(43) Pub. Date: Jul. 17, 2025

(54) INSTRUMENT PANEL REINFORCEMENT

(71) Applicant: FUTABA INDUSTRIAL CO., LTD., Okazaki-shi (JP)

(72) Inventors: Kaoru Tsuge, Okazaki-shi (JP); Hirotaka Niinomi, Okazaki-shi (JP)

(21) Appl. No.: 19/001,712

(22) Filed: Dec. 26, 2024

(30) Foreign Application Priority Data
Jan. 16, 2024 (JP) 2024-004438

(51) Int. Cl. B62D 25/14

(52) U.S. Cl. CPC B62D 25/145

(57) ABSTRACT

An instrument panel reinforcement includes a main body and a flattened portion. The main body has a tubular shape extending from a first end to a second end along a vehicle-width direction. The flattened portion is formed in the main body at a position apart from the first end and the second end and allows a peripheral component to be arranged thereon. The flattened portion is a dent in the main body, having a cross-section perpendicular to the vehicle-width direction in a dented shape such that an inner space within the main body is flattened in a first direction, the first direction being a direction perpendicular to the vehicle-width direction. The flattened portion includes a mounting portion. The mounting portion is where inner-circumferential surfaces of the main body, which face each other, are substantially in contact with each other, and on which the peripheral component is mounted.

### CROSS-REFERENCE TO RELATED APPLICATIONS

This application claims the benefit of Japanese Patent Application No. 2024-004438 filed on Jan. 16, 2024 with the Japan Patent Office, the entire disclosure of which is incorporated herein by reference.

### BACKGROUND

The present disclosure relates to an instrument panel reinforcement.

Japanese Unexamined Patent Application Publication No. 2009-107449 discloses an instrument panel reinforcement with a cylindrical shape extending in a vehicle-width direction, in which a steering column mounting portion is shaped flatter than other portions so as to have a higher stiffness than the other portions.

### SUMMARY

Recent growing demand for electric vehicles and/or for multifunctional vehicles drives an increasing number of peripheral components provided around fronts of driver's seat and passenger's seat of a vehicle. Since brackets are used for mounting the peripheral components to an instrument panel reinforcement, it is necessary to save spaces for the brackets besides for the peripheral components. With the instrument panel reinforcement disclosed in Japanese Unexamined Patent Application Publication No. 2009-107449, there is a problem that an available space is too limited to arrange the peripheral components.

In one aspect of the present disclosure, it is preferable to provide a technique for providing more space for the peripheral components to be arranged.

One aspect of the present disclosure is to provide an instrument panel reinforcement comprising: a main body; and at least one flattened portion. The main body has a tubular shape extending from a first end to a second end along a vehicle-width direction. The at least one flattened portion is formed in the main body at a position apart from the first end and the second end and allows a peripheral component to be arranged thereon. The at least one flattened portion is a dent in the main body, having a cross-section perpendicular to the vehicle-width direction in a dented shape such that an inner space within the main body is flattened in a first direction, the first direction being a direction perpendicular to the vehicle-width direction. The at least one flattened portion includes a mounting portion. The mounting portion is where inner-circumferential surfaces of the main body, which face each other, are substantially in contact with each other, and on which the peripheral component is mounted.

In such a configuration, at an area in the main body where the at least one flattened portion is formed, a space is formed around the main body, having a volume corresponding to an amount that the main body is dented in the first direction. Because of this, it is possible to provide more space for the peripheral components to be arranged.

In one aspect of the present disclosure, the mounting portion may be substantially flat.

Such a configuration makes it easy to directly mount the peripheral component to the mounting portion. Thus, the peripheral component can be mounted to the instrument panel reinforcement without using any bracket.

In one aspect of the present disclosure, the mounting portion may be located, as viewed in the vehicle-width direction, inside an outer diameter region, the outer diameter region being situated between tangents to a cross section of an outer-circumferential surface of a part of the main body adjacent to the at least one flattened portion that are made at two points where the cross section and a line extending in the first direction through a center point of the main body intersect.

It is desirable that the main body extends straight along the vehicle-width direction. However, if the mounting portion is located outside the outer diameter region, the main body becomes easily warpable. On the other hand, when the main body is configured as described above, it is possible to reduce warping of the main body.

In one aspect of the present disclosure, at least one flattened portion may have a bead at the mounting portion. The bead protrudes from the mounting portion in the first direction.

In such a configuration, it is possible with the bead to improve stiffness of the main body.

### BRIEF DESCRIPTION OF THE DRAWINGS

An example embodiment of the present disclosure will be described hereinafter by way of example with reference to the accompanying drawings, in which:

FIG. 1 is a front view of an instrument panel reinforcement;

FIG. 2A is a cross-sectional view taken along IIA-IIA in FIG. 1;

FIG. 2B is a cross-sectional view taken along IIB-IIB in FIG. 1;

FIG. 3 is a front view of a flattened portion according to a first modified example;

FIG. 4 is a front view of a flattened portion according to a second modified example;

FIG. 5 is a cross-sectional view of a flattened portion according to a third modified example along a first direction; and

FIG. 6 is a cross-sectional view of a flattened portion according to a fourth modified example along the first direction.

### DETAILED DESCRIPTION OF EXEMPLARY EMBODIMENTS

### [1. Configuration]

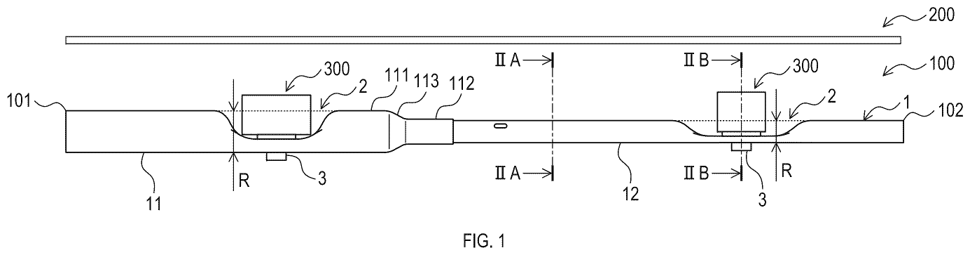

An instrument panel reinforcement 100 shown in FIG. 1 is provided inside a front interior component 200, such as an instrument panel or a dashboard, that is disposed in front of a driver's seat and a passenger's seat of a vehicle along a vehicle-width direction (in other words, a right-left direction of a vehicle). The instrument panel reinforcement 100 is fixed to a vehicle body, for example, via unillustrated brackets that are arranged on both ends of the instrument panel reinforcement 100 along the vehicle-width direction. A peripheral component 300 arranged in the front interior component 200 is mounted to the instrument panel reinforcement 100. The peripheral component 300 is, for example, a head-up display or an airbag. Hereinafter, expressions of front, rear, up and down relative to the vehicle will be simply referred to as front, rear, up and down. The vehicle referred in this embodiment is, as one example, a left-hand driven vehicle.

The instrument panel reinforcement 100 comprises: a main body 1; and a flattened portion 2.

The main body 1 has a tubular shape extending from a first end 101 to a second end 102 along the vehicle-width direction. The main body 1 includes: a first cylinder 11; and a second cylinder 12.

The first cylinder 11 is a cylindrical member that is located in front of the driver's seat and supports a steering via a support member. The first cylinder 11 has a substantially circular shape in a cross section perpendicular to the vehicle-width direction (hereinafter, simply referred to as a cross section) except in a portion where the flattened portion 2 is formed. The first cylinder 11 includes: a large-diameter portion 111; a small-diameter portion 112; and an intermediate portion 113.

The large-diameter portion 111 has a substantially fixed outer diameter except in a portion where the flattened portion 2 is formed. The small-diameter portion 112 has a substantially fixed outer diameter that is smaller than the outer diameter of the large-diameter portion 111. The intermediate portion 113 connects the large-diameter portion 111 and the small-diameter portion 112 and decreases in diameter from the large-diameter portion 111 toward the small-diameter portion 112.

The second cylinder 12 is a cylindrical member that is located in front of passenger's seat and has an outer diameter smaller than an inner diameter of the small-diameter portion 112. The second cylinder 12 has a substantially circular shape in a cross section and has a substantially fixed outer diameter except in a portion where the flattened portion 2 is formed.

One end of the second cylinder 12 is inserted to and joined to the small-diameter portion 112 by welding or the like, and thus the first cylinder 11 and the second cylinder 12 are joined together, thereby forming the main body 1. The large-diameter portion 111 of the first cylinder 11 extends to the first end 101 of the main body 1, and the second cylinder 12 extends to the second end 102 of the main body 1.

The flattened portion 2 is formed at a position apart from the first end 101 and the second end 102 in the main body 1 and allows the peripheral component 300 to be arranged thereon. In the present embodiment, the large-diameter portion 111 of the first cylinder 11 and the second cylinder 12 each is provided with a single flattened portion 2. The main body 1 is provided with two flattened portions 2 in total. The number of the flattened portions formed in the main body may be one or three or more. The flattened portion 2 is formed at any position in the vehicle-width direction in the large-diameter portion 111 and the second cylinder 12. In the main body, the flattened portion may be provided at either one of the large-diameter portion and the second cylinder.

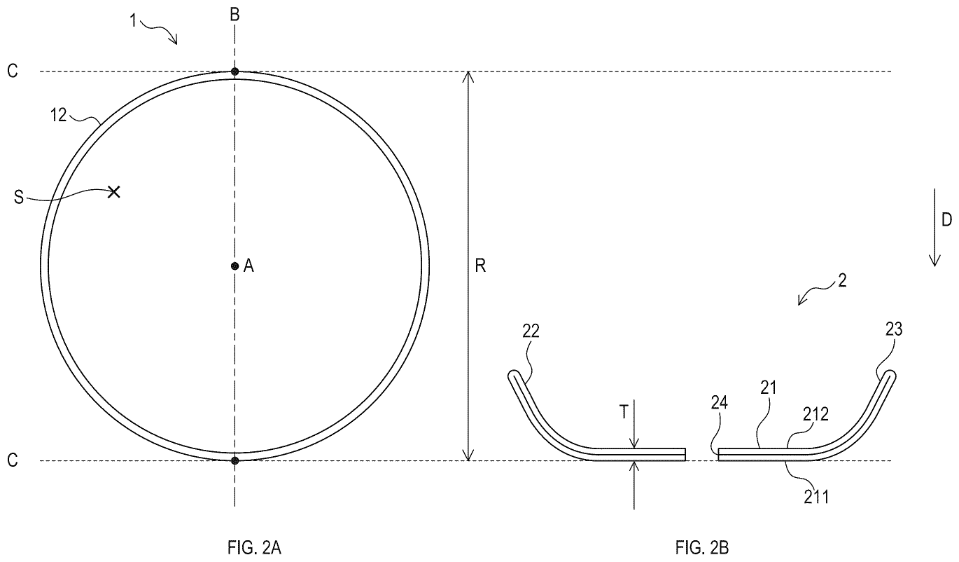

Each of the flattened portions 2 is formed by pressing the large-diameter portion 111 and the second cylinder 12 using press-forming method. The flattened portions 2 provided in the large-diameter portion 111 and the second cylinder 12 have a similar shape. Therefore, descriptions hereinafter will be given of the flattened portion 2 provided in the second cylinder 12 by referring to FIGS. 2A and 2B, and descriptions of the flattened portion 2 provided in the large-diameter portion 111 will be omitted. In FIG. 2B, the peripheral component 300 and a fastening member 3 are not illustrated.

Specifically, the second cylinder 12 is dented in a first direction D, which is perpendicular to the vehicle-width direction, through a flattening process, such that an inner space S within the second cylinder 12 as illustrated in FIG. 2A is flattened. In the present embodiment, for example, the second cylinder 12 is dented downward. The flattened portion 2 having a dented cross-section as illustrated in FIG. 2B is thus formed in the second cylinder 12. Here, a direction in which the first direction D is directed not limited to downward, but may be any direction perpendicular to the vehicle-width direction, for example, upward, forward, or rearward. In other words, the position in the second cylinder 12 in a circumferential direction where the flattened portion 2 is formed is not limited.

As illustrated in FIG. 2B, the flattened portion 2 includes: a mounting portion 21; a first wall 22; a second wall 23; and a through hole 24.

The mounting portion 21 is where inner-circumferential surfaces of the second cylinder 12 facing each other are substantially in contact with each other. What is meant by being substantially in contact is two portions being in contact with each other or being arranged with a small clearance therebetween. A thickness T of the mounting portion 21 is about twice as thick as a thickness between the inner-circumferential surface and an outer-circumferential surface of the second cylinder 12.

In the present embodiment, the mounting portion 21 is substantially flat and, for example, expands in the vehicle-width direction and in a vehicle-front-rear direction. Examples of a substantially flat surface include a flat surface and a not-completely flat surface that is slightly curved or slightly bent. The mounting portion 21 includes an outer surface 211 and an inner surface 212. The outer surface 211 is located further in the first direction D in the mounting portion 21. The inner surface 212 faces the outer surface 211 and forms a bottom surface of the flattened portion 2. In the present embodiment, the outer surface 211 faces downward, and the inner surface 212 faces upward.

As illustrated in FIGS. 2A and 2B, in the present embodiment, the mounting portion 21 is situated in an outer diameter region R as viewed in the vehicle-width direction. The outer diameter region R is an area situated between tangents C to the cross section of the outer-circumferential surface of a part of the second cylinder 12 adjacent to the flattened portion 2 that are made at two points where the cross section and a line B extending in the first direction D through a center point A of the second cylinder part 12 intersect. In other words, the outer diameter region R is an area between outer diameter planes that include the tangents C and extend in the vehicle-width direction. Specifically, the outer surface 211 of the mounting portion 21 is arranged to be substantially coplanar with the outer diameter plane including the tangents C that is located further in the first direction D out of the two tangents C. In the outer diameter region R, the outer surface of the mounting portion may not be necessarily substantially coplanar with the outer diameter plane, but may be arranged at any position apart from the outer diameter plane.

The first wall 22 and the second wall 23 face each other spaced apart each other, and each extends in a direction opposite to the first direction D from an end of the mounting portion 21 along a direction perpendicular to the vehicle-width direction (for example, in the front-rear direction). A distance between the first wall 22 and the second wall 23 increases as they are further from the mounting portion 21. The first wall 22 and the second wall 23 each configures a lateral surface of the flattened portion 2. In the present embodiment, the inner-circumferential surfaces of the second cylinder 12 that face each other are substantially in contact with each other in the first wall 22 and the second wall 23.

The through hole 24 is formed in the mounting portion 21 and penetrates through the outer surface 211 and the inner surface 212 of the mounting portion 21.

In the present embodiment, as illustrated in FIG. 1, the peripheral component 300 is directly mounted to each flattened portion 2. Specifically, the peripheral component 300 is arranged to abut the inner surface 212 of the mounting portion 21, and then the peripheral component 300 is joined to the mounting portion 21, for example, with use of the fastening member 3, which is arranged to be inserted into the through hole 24 or to come into contact with an edge of the through hole 24. Examples of the fastening member 3 include a bolt, a nut, and a caulking nut. Moreover, the fastening member may be provided in the peripheral component. The peripheral component may be mounted to the mounting portion 21 via another member, such as a bracket.

### [2. Effects]

The embodiment detailed above provides the following effects.

(2a) In the present embodiment, at the area in the large-diameter portion 111 and the second cylinder 12 of the first cylinder 11 (that is, the main body 1) where each of the flattened portions 2 are formed, a space is formed, around the large-diameter portion 111 and the second cylinder 12, having a volume corresponding to an amount that each of the large-diameter portion 111 and the second cylinder 12 is dented in the first direction D. This makes it possible to provide a more space around the main body 1 as compared with a case where the instrument panel reinforcement 100 does not include the flattened portion 2. Specifically, it is possible to provide more space for the peripheral component 300 to be arranged. This results in improvement of a shape flexibility (in other words, a design flexibility) of the front interior component 200 covering a periphery of the instrument panel reinforcement 100.

(2b) In the mounting portion of the flattened portion configured to have a clearance between the inner-circumferential surfaces of the large-diameter portion or the second cylinder, which face each other, when the peripheral component 300 is mounted to the mounting portion using the fastening member 3 (for example, a bolt and a nut), an axial force is generated on the fastening member 3 in a direction to eliminate the clearance. Due to this, the flattened portion is easily deformed. In the present embodiment, on the other hand, in the mounting portion 21 of the flattened portion 2, the inner-circumferential surfaces of the large-diameter portion 111 or the second cylinder 12, which face each other, are substantially in contact with each other. Therefore, hardly any clearance is produced between the inner-circumferential surfaces. This inhibits deformation of the flattened portion 2 when the peripheral component 300 is mounted to the mounting portion 21 using the fastening member 3. Moreover, in the present embodiment, a space can be formed, in a periphery of the large-diameter portion 111 and the second cylinder 12, with a large volume as compared with a case in which the mounting portion is configured to have a clearance between the inner-circumferential surfaces of the large-diameter portion or the second cylinder, which face each other.

(2c) In the present embodiment, the mounting portion 21 is substantially flat. For this reason, the peripheral component 300 is easily directly mounted to the mounting portion 21 and thus can be mounted to the instrument panel reinforcement 100 without using any bracket. This allows the space for arranging the peripheral component 300 to have a large volume as compared with a case in which the peripheral component 300 is mounted to the instrument panel reinforcement 100 using a bracket. Furthermore, since the peripheral component 300 is mounted to the instrument panel reinforcement 100 without using any bracket, a reduction in the number of components and weight-reduction of required components can also be achieved.

(2d) It is desirable that the main body 1 extends straight along the vehicle-width direction. However, if the mounting portion of each of the flattened portions provided in the large-diameter portion and the second cylinder is located outside the outer diameter region R, the large-diameter portion and the second cylinder can/may become easily warpable. In the present embodiment, on the other hand, the mounting portion 21 is located inside the outer diameter region R, resulting in reduction of warping of the large-diameter portion 111 and the second cylinder 12.

(2e) In the present embodiment, each of the flattened portions 2 is formed through the flattening process. Because of this, a position accuracy is ensured in an outer-circumferential surface of the part of the second cylinder 12 adjacent to the flattened portion 2 and an outer-circumferential surface of a part of the large-diameter portion 111 adjacent to the flattened portion 2. Specifically, in the present embodiment, it is possible to form the flattened portions 2 such that a position of the outer-circumferential surface of the part of the second cylinder 12 adjacent to the flattened portion 2 and a position of the outer-circumferential surface of the part of the large-diameter portion 111 adjacent to the flattened portion 2 are almost unchanged before and after being subjected to the flattening process.

### [3. Other Embodiments]

The above has described the embodiment according to the present disclosure. However, it goes without saying that the present disclosure is not limited to the aforementioned embodiment and may be embodied in various forms.

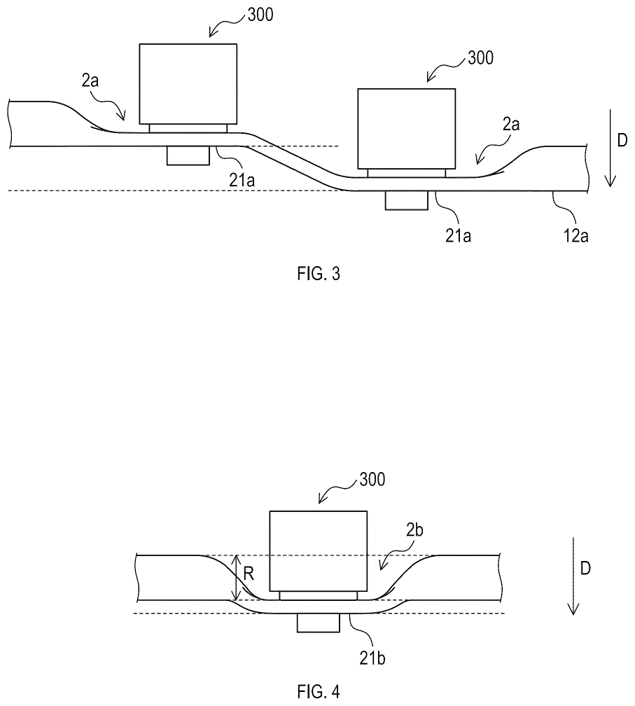

(3a) In the above-described embodiment, the second cylinder 12 is provided with a single flattened portion 2. However, the second cylinder may be provided with, for example, a plurality of flattened portions. In a case where the second cylinder is provided with a plurality of flattened portions, for example, the plurality of flattened portions may be provided in the second cylinder such that each of the mounting portions are located on a substantially flush plane. Moreover, for example, as illustrated in FIG. 3, a plurality of the flattened portions 2a in the first modified example may be provided in the second cylinder 12a such that mounting portions 21a are positioned on planes located differently from one another in the first direction D. The large-diameter portion of the first cylinder may also be provided with a plurality of flattened portions configured similarly to the above-described plurality of flattened portions in the second cylinder.

(3b) In the above-described embodiment, the mounting portion 21 of the flattened portion 2 is located inside the outer diameter region R. However, for example, as illustrated in FIG. 4, a mounting portion 21b of the flattened portion 2b in the second modified example may be located outside the outer diameter region R. Even in such a configuration, it is possible to provide a larger space for arranging the peripheral component 300.

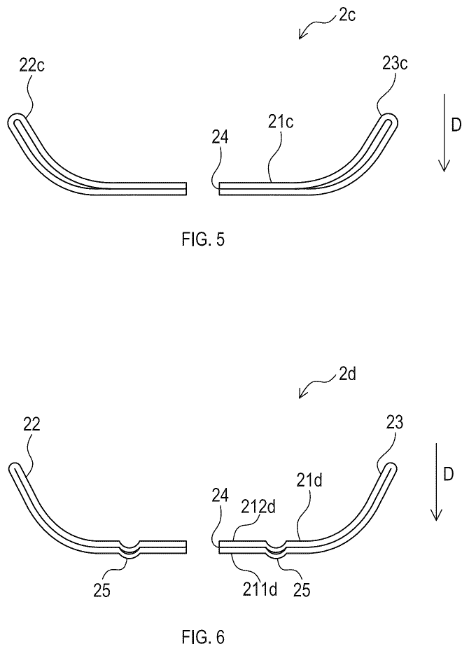

(3c) In the above-described embodiment, the inner-circumferential surfaces of the large-diameter portion 111 or the second cylinder 12, which face each other, are substantially in contact with each other in all of the mounting portion 21, the first wall 22, and the second wall 23 of the flattened portion 2. However, for example, as illustrated in FIG. 5, the flattened portion 2c in the third modified example may be formed to have a clearance between a first wall 22c and a second wall 23c. Specifically, the inner-circumferential surfaces of the large-diameter portion or the second cylinder, which face each other, may be substantially in contact with each other in only a mounting portion 21c of the flattened portion 2c.

(3d) For example, as illustrated in FIG. 6, the flattened portion 2d in the fourth modified example may include a bead 25 at a mounting portion 21d. The bead 25 is a raised portion protruding from the mounting portion 21d in the first direction D. Specifically, the bead 25 is formed by an outer surface 211d and an inner surface 212d of the mounting portion 21d together protruding in the first direction D. There may be a plurality of beads 25 formed around the through hole 24, which is provided at the mounting portion 21d. In such a configuration, it is possible with the bead 25 to improve stiffness of the main body (specifically, the first cylinder and the second cylinder each provided with the flattened portion 2d). The bead may be a raised portion protruding from the mounting portion in the direction opposite to the first direction D, and the bead configured as descried above makes it possible to achieve improvement of stiffness of the main body.

(3e) The first cylinder 11 and the second cylinder 12 in the above-described embodiment each has a substantially circular cross section, but the first cylinder and the second cylinder each may have a shape other than this. For example, the cross section of each of the first cylinder and the second cylinder may have an ellipse shape or a polygonal shape.

(3f) The mounting portion 21 in the above-described embodiment is substantially flat, but the mounting portion may be, for example, in a curved shape.

(3g) It may be possible to divide a function of one element in the above- described embodiment to a plurality of elements, or to integrate functions of a plurality of elements into one element. The configurations in the above-described embodiments may be partly omitted. At least part of the configuration of the above-described embodiments may be added to or replaced with the configuration of other embodiments described above.

What is claimed is:

1. An instrument panel reinforcement comprising:
a main body having a tubular shape extending from a first end to a second end along a vehicle-width direction; and
at least one flattened portion formed in the main body at a position apart from the first end and the second end and allowing a peripheral component to be arranged thereon,
wherein the at least one flattened portion is a dent in the main body, having a cross-section perpendicular to the vehicle-width direction in a dented shape such that an inner space within the main body is flattened in a first direction, the first direction being a direction perpendicular to the vehicle-width direction, and
wherein the at least one flattened portion includes a mounting portion where inner-circumferential surfaces of the main body, which face each other, are substantially in contact with each other, and on which the peripheral component is mounted.

2. The instrument panel reinforcement according to claim 1,
wherein the mounting portion is substantially flat.

3. The instrument panel reinforcement according to claim 1,
wherein the mounting portion is located, as viewed in the vehicle-width direction, inside an outer diameter region, the outer diameter region being situated between tangents to a cross section of an outer-circumferential surface of a part of the main body adjacent to the at least one flattened portion that are made at two points where the cross section and a line extending in the first direction through a center point of the main body intersect.

4. The instrument panel reinforcement according to claim 1,
wherein the at least one flattened portion includes, at the mounting portion, a bead protruding from the mounting portion in the first direction.
